(19) United States
(12) Patent Application Publication
(10) Pub. No.: US 2014/0244378 A1
(43) Pub. Date: Aug. 28, 2014

(54) SYSTEM AND METHOD FOR PROVIDING REAL TIME RESPONSE TO CUSTOMER ACTIVITY

(71) Applicants: Darin Brown, Indianapolis, IN (US); Jeff Middlesworth, Indianapolis, IN (US)

(72) Inventors: Darin Brown, Indianapolis, IN (US); Jeff Middlesworth, Indianapolis, IN (US)

(73) Assignee: EXACTTARGET, INC., Indianapolis, IN (US)

(21) Appl. No.: 14/170,447

(22) Filed: Jan. 31, 2014

Related U.S. Application Data
(60) Provisional application No. 61/768,174, filed on Feb. 22, 2013.

(51) Int. Cl. G06Q 30/02

(52) U.S. Cl. CPC G06Q 30/0269
USPC 705/14.41; 705/14.66; 705/14.61

(57) ABSTRACT

A computerized method and system for providing real-time response to consumer activity is disclosed. The method and system includes receiving a consumer activity, the consumer activity being associated with marketing engagement by a consumer, analyzing the consumer activity to determine one or more changes to previously known attributes of the consumer stored in a database, pushing the one or more changes into a data queue, processing the one or more changes from the data queue based on a business logic process, the business logic process comprising one or more marketing activities and a timing for each marketing activity of the one or more marketing activities, and performing the one or more marketing activities based at least in part on the business process.

### PRIORITY

This application claims priority to and the benefit of U.S. Provisional Application No. 61/768,174, filed on Feb. 22, 2013, which is incorporated herein by reference.

### BACKGROUND

Customers engage brands through a variety of channels, including, but not limited to, mobile, social, web, and email. Through these channels, customers interact with the brand in a variety of ways. A customer might purchase an item through an online retailer, click a link found within an email, update certain information about themselves through the brand's online portal, and even “Like” the brand's Facebook presence.

From time to time, a customer might interact with the brand through these channels in a way in which the brand may wish to capitalize. For example, a customer purchasing a pair of snow skis from the brand may be interested in an upsell opportunity from the brand for a pair of snow boots or other equipment related to the snow skis. In another example, a customer choosing to “Like” a brand's Facebook presence may be also interested in Following the brand's Twitter handle.

In isolation, an enterprise managing their brand might miss these opportunities for increased engagement. Today, enterprises attempt to react to customer activity through batch processes that fail to engage the customer at a time when the customer is most interested in the brand—soon after the point of interaction. Accordingly, there exists a need for a system and method to provide real-time response to customer activity.

Each customer of a brand interacts with that brand differently. A customer that is heavily engaged in a brand may be interested in a completely different type of interaction with the brand than a customer that is only lightly engaged in the same brand. That is, even though two customers may perform the same activity with a brand, an enterprise should react differently to each customer's interaction with the brand in order to further the engagement with that customer. For example, suppose an online retailer is engaged by two types of customers, the heavily engaged customer and the lightly engaged customer, the heavily engaged customer who purchases snow skis from an online retailer may be inclined to make a second purchase if immediately rewarded with an exclusive coupon associated with a 25% discount on their next purchase. However, the customer with only a light engagement with the online retailer's brand but who makes the same purchase of snow skis may only receive a communication that shows the types of products associated with the snow skis that the customer may want to view. Today, it is difficult to determine the type of customer engaged in an activity and, accordingly, enterprises engage customers that perform the same types of activities in exactly the same way. Accordingly, there exists a need for a system and method to provide real-time responses to customer activity that can identify the best way to engage with the customer based on information known about the customer.

### BRIEF DESCRIPTION OF THE DRAWINGS

FIG. 1A displays a flowchart of a method for providing real-time response to customer activity according to at least one embodiment of the present disclosure.

FIG. 1B displays a graph detailing benefits of a method and system for providing real-time response to customer activity according to at least one embodiment of the present disclosure.

FIG. 2A displays a flowchart of a method for providing real-time response to customer activity according to at least one embodiment of the present disclosure.

FIG. 2B displays a flowchart of a method for providing real-time response to customer activity according to at least one embodiment of the present disclosure.

FIG. 2C displays a flowchart of a method for providing real-time response to customer activity according to at least one embodiment of the present disclosure.

FIG. 3 displays components of a system for providing real-time response to customer activity according to at least one embodiment of the present disclosure.

FIG. 4 displays a flowchart of a method for providing real-time response to customer activity according to at least one embodiment of the present disclosure.

FIG. 5 displays a flowchart of a method for providing real-time response to customer activity according to at least one embodiment of the present disclosure.

FIG. 6A displays a wireframe template of a graphical user interface generated through execution of a method or system for providing real-time response to customer activity according to at least one embodiment of the present disclosure.

FIG. 6B displays a wireframe template of a graphical user interface generated through execution of a method or system for providing real-time response to customer activity according to at least one embodiment of the present disclosure.

FIG. 7 displays a wireframe template of a graphical user interface generated through execution of a method or system for providing real-time response to customer activity according to at least one embodiment of the present disclosure.

FIG. 8 displays a wireframe template of a graphical user interface generated through execution of a method or system for providing real-time response to customer activity according to at least one embodiment of the present disclosure.

FIG. 9 displays a wireframe template of a graphical user interface generated through execution of a method or system for providing real-time response to customer activity according to at least one embodiment of the present disclosure.

FIG. 10 displays a flowchart of a method for providing real-time response to customer activity according to at least one embodiment of the present disclosure.

### DETAILED DESCRIPTION

In the present disclosure, a system and method for providing real-time response to customer activity is disclosed. The system and methods disclosed herein enable an enterprise to process and respond to customer activity in real time in order to try to further engage the customer.

The systems and methods described in the present disclosure enable the configuration of certain communications by an enterprise and of content within such communications. It should be appreciated that the systems and methods disclosed herein may produce any sort of marketing communication sent to a recipient, such as, for example, email, SMS, MMS, Facebook message, Twitter direct connect, LinkedIn message, and others.

While this disclosure has been described as having various embodiments, these embodiments according to the present disclosure can be further modified within the scope and spirit of this disclosure. This application is therefore intended to cover any variations, uses, or adaptations of the disclosure using its general principles. For example, any methods disclosed herein represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

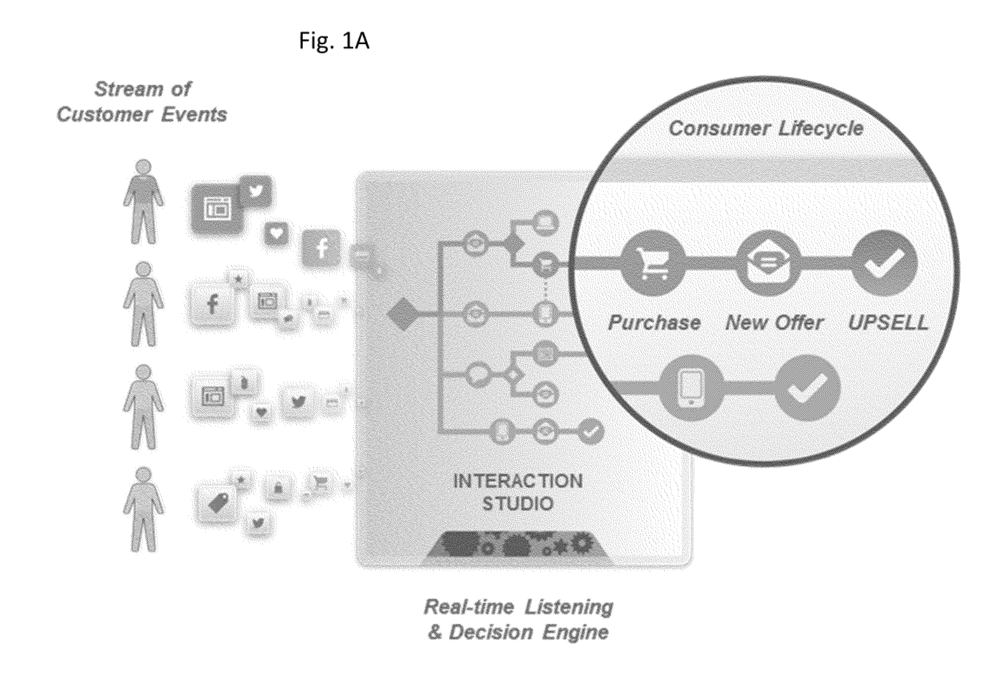

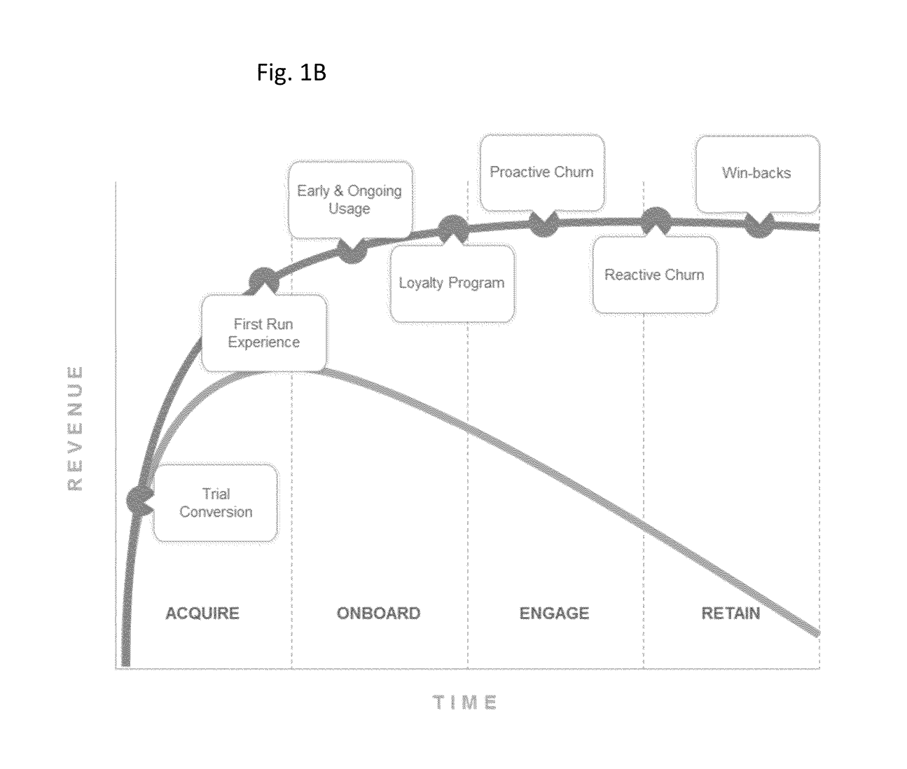

Referring now to FIG. 1A, it is shown a diagram of a method and system for providing real-time response to customer activity according to at least one embodiment of the present disclosure. As shown in FIG. 1A, the diagram includes a stream of customer events from a variety of sources flowing into a real-time listening and decision engine that processes the customer events to provide a response. As used in the present disclosure, a customer event includes information generated through activities by a customer through one or more marketing channels, such as, for example, Facebook, email, web, Twitter, LinkedIn, mobile, and others. This information may be related to the types of activities customers may perform through such channels, such as, for example, providing an email address through a web form, choosing to “Like” a Facebook page, following a Twitter handle, purchasing a product through an online retailer, sending an SMS message, clicking a hyperlink within an email or website, and others.

As shown in the diagram in FIG. 1A, a customer performing an activity through a website that generates information will flow through to a real-time listening and decision engine in order to be processed to determine whether any response should be made to that certain customer activity. For example, a customer may have purchased an item on a website, filled out a form on the website, or generally interacted with the website in a way that might show interest in one or more products. The information generated through this customer activity is provided to or obtained by a real-time listening and decision engine for processing. As shown in the diagram, the real time listening and decision engine may have a business workflow in order to determine, based on information already known about the customer, how to react to the customer activity in order to further engage with the customer.

The real-time listening and decision engine may respond to different customers in different ways, even if each customer performed the same activity. Referring now to FIG. 1B, a graph is shown that represents the types of categories a customer may be evaluated within according to at least one embodiment of the present disclosure. As shown in the graph, an enterprise could attempt to put customers within certain classes based on the lifecycle of the customer. In this example, a customer that is new to engagement with the enterprise may be classified in the acquire stage of engagement, whereas a customer that has already made many purchases may be classified in the engage stage of engagement. It should be appreciated that each level of engagement by the customer may be used to identify how to appropriately respond to customer activity within the real-time listening and decision engine shown in FIG. 1A. As discussed herein, how to classify a customer may vary by enterprise and the classifications shown in FIG. 1B are merely examples of types of classifications of customers based on the length of time the customer has been engaged with a brand and the types of activities performed by that customer. It should be appreciated that any type of customer classification system may be used within the real time listening and decision engine within the scope of the present disclosure and that the example shown in FIG. 1B is merely for illustrative purposes.

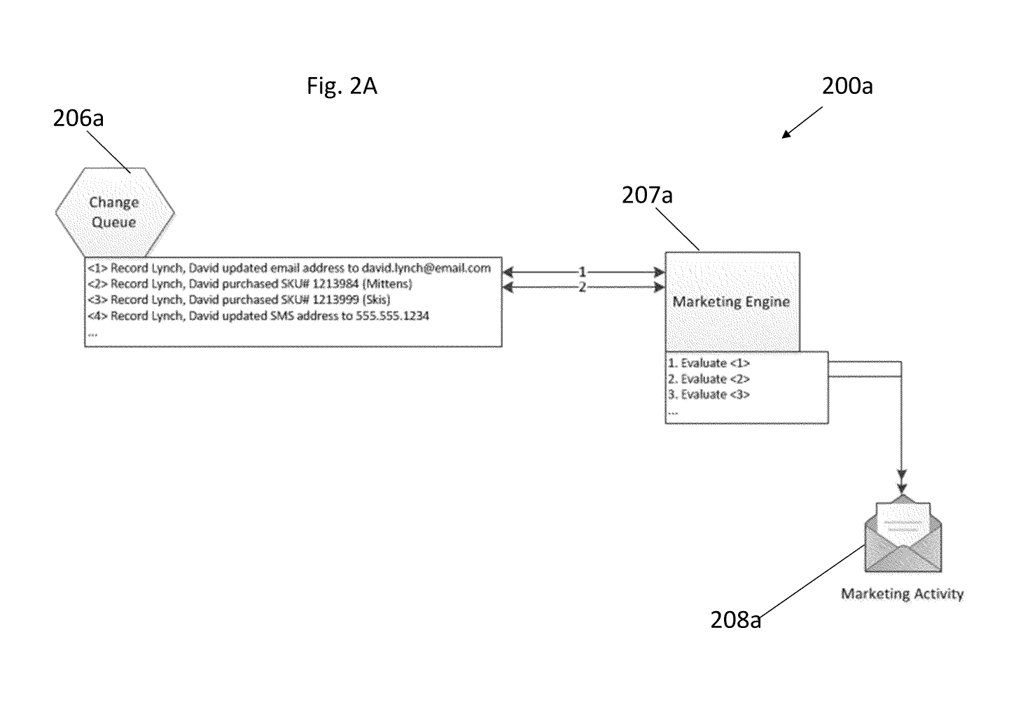

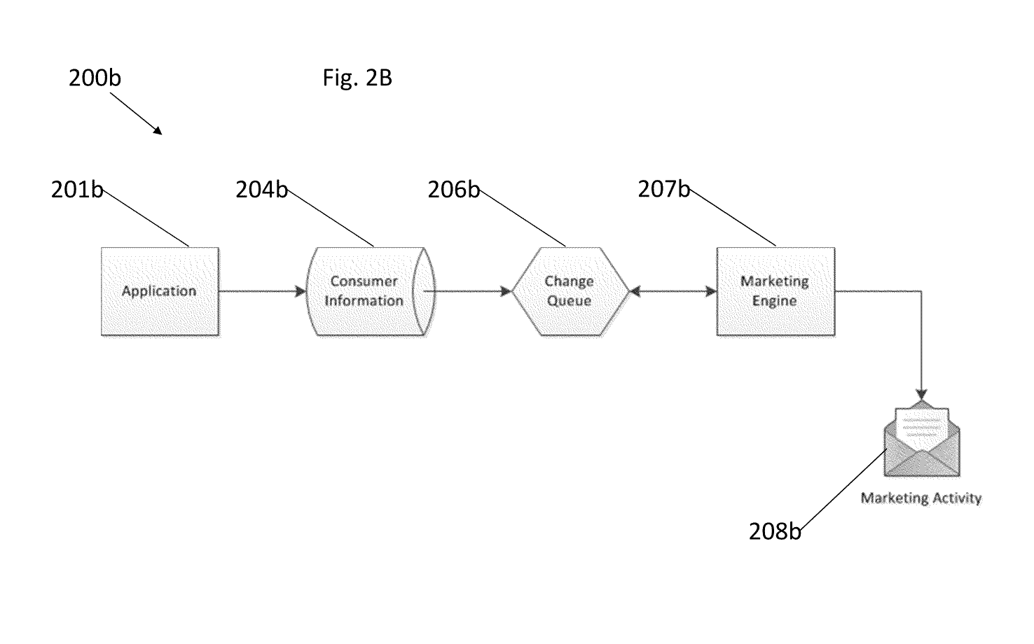

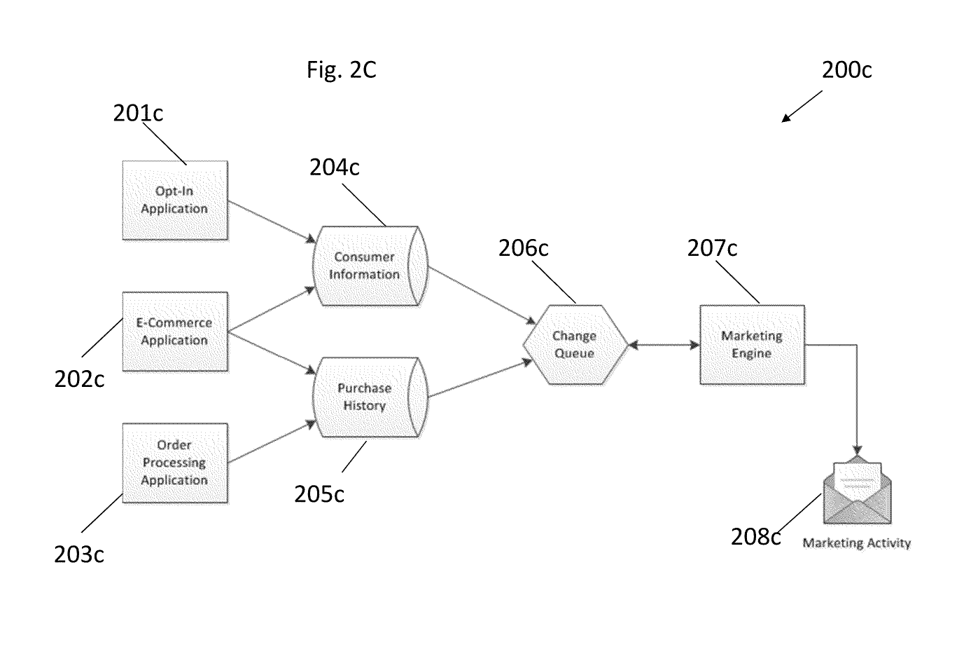

Referring now to FIG. 2A, it is shown a diagram 200a of a system and example of execution of a method for providing real-time response to customer activity is shown according to at least one embodiment of the present disclosure. As shown in FIG. 2A, the diagram 200a includes a chance queue 206a, a marketing engine 207a, and resulting marketing activity 208a.

In at least one embodiment of the present disclosure, a change queue 206a is included in a system and method for providing real-time response to customer activity. In such an embodiment, the change queue 206a holds information generated from customer activity in a queue or data structure until that information may be processed by the marketing engine 207a. In such an embodiment, the change queue 206a receives customer activity from one or more sources (not pictured) as input through an application programming interface calling process if the providing entity is remote from the change queue 206a or through a file or data structure if the providing resource is local to the change queue 206a. Alternatively, the change queue 206a may pull information from one or more sources through application programming interfaces or other interactive channels through such sources. It should be appreciated that the sources may be remote from the change queue 206 and/or accessible through application programming interfaces over a computer network (i.e., the Internet).

It should be appreciated that information received or pulled from sources may be stored in a variety of ways. In at least one embodiment of the present disclosure, information may be stored with a unique identifier that indicates the point in time that the information arrived to the change queue 206a. As shown in FIG. 2A, an example of an identifier may include a tag that increments as new information arrives, such as, for example, <1>, <2>, <3>, etc.

In at least one embodiment of the present disclosure, the type of information stored in the change queue 206a includes customer activity information. For example, as shown in FIG. 2A, the information stored may be associated with information that has changed about a certain customer, such as, for example David Lynch. In this example, the change queue 206a holds information showing that David Lynch has updated his email address within one source to david.lynch@email.com with an identifier of <1>, information noting that David Lynch has purchased SKU#1213984 associated with mittens with an identifier of <2>, David Lynch has purchased SKU#1213999 associated with skis with an identifier of <3>, and that David Lynch has updated his mobile SMS address to 555.555.1234 with an identifier of <4>.

It should be appreciated that although the example in FIG. 2A only shows information resulting from activity performed by David Lynch, the information stored in the change queue 206a may be associated with any number of customers, may include any identifier, and may be included in any format. The example shown in FIG. 2A, therefore, is simply an example for illustrative purposes only. The change queue 206a may be implemented as any time of queuing structure or data structure, including, but not limited to, a FIFO queue, a linked list, a priority queue, a circular buffer, a stack, or tree. The change queue 206a may also be implemented through message queuing technologies, such as, for example, IBM Websphere, Apache Kafka, Apache ActiveMQ, Oracle AQ, StormMQ, IronMQ, or Solace.

In at least one embodiment of the present disclosure, information stored in the change queue 206a is processed by a marketing engine 207a according to the implementation of the data structure or properties of the change queue 206a. In at least one embodiment of the present disclosure, the marketing engine 207a is an implementation of the real time listening and decision engine shown in FIG. 1A. The marketing engine 207a evaluates information stored in the change queue 206a to determine what, if any, marketing activity 208a should be generated based on the information.

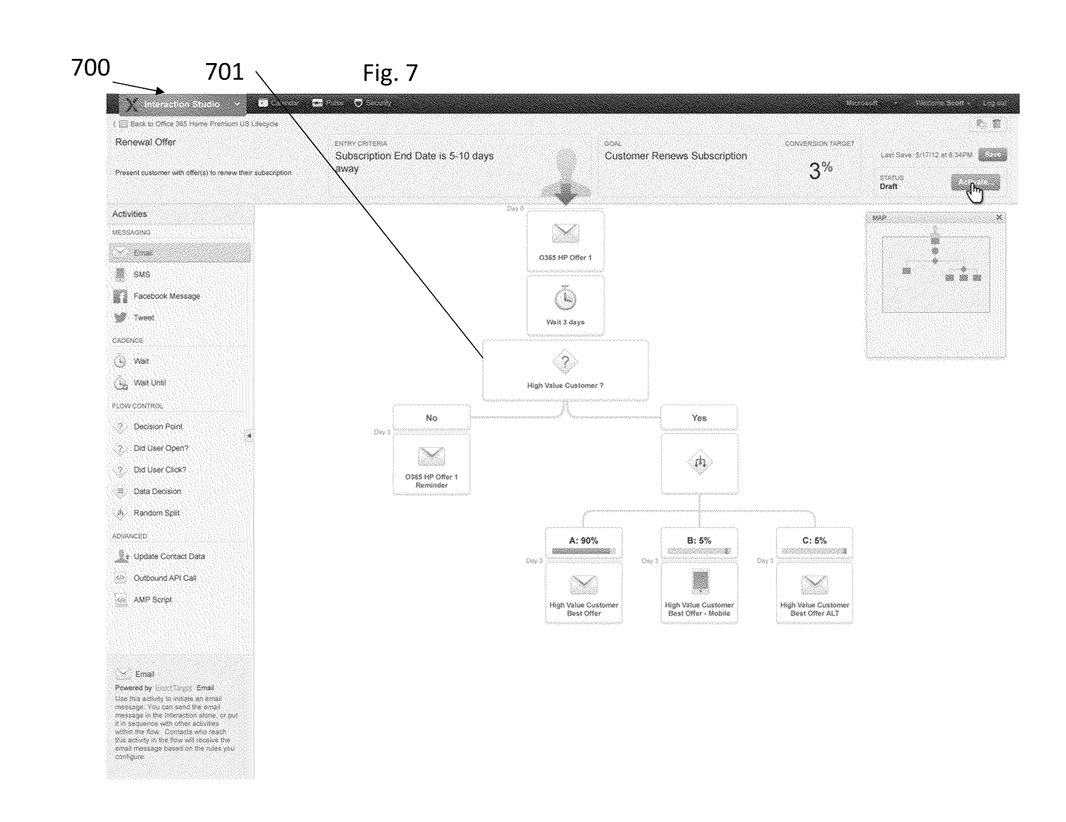

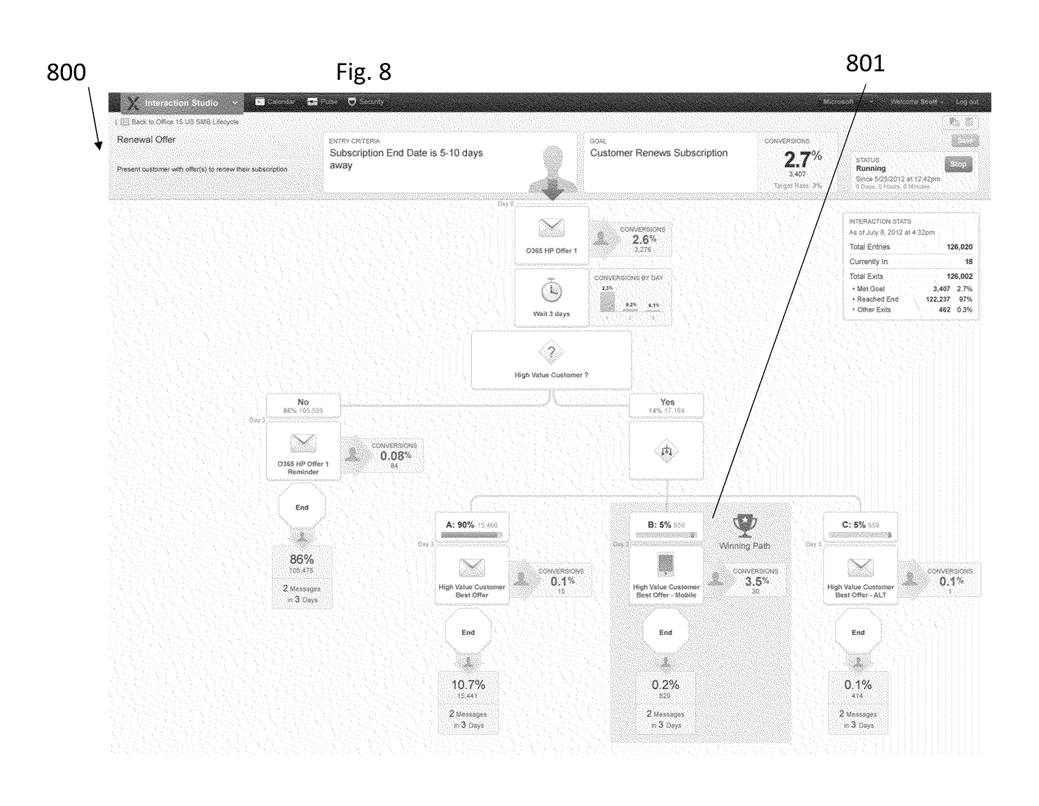

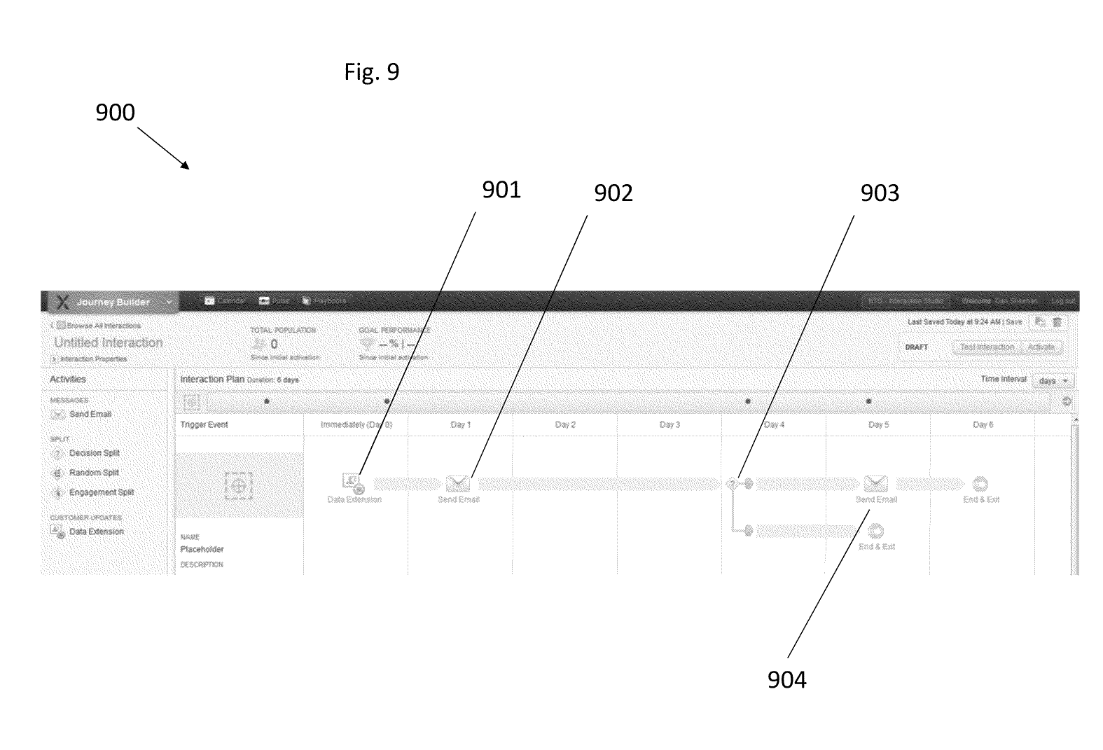

In at least one embodiment of the present disclosure, the marketing engine 207a includes various interaction engines that evaluate incoming customer information from the change queue 206a in relation to one or more attributes about the customer in order to determine what activity should be generated in an attempt to further engage the customer. In at least one embodiment of the present disclosure, the interaction engine includes a process workflow and decision tree that may make choices about what activity to generate based on the type of customer engaged, a schedule, a certain marketing channel engaged, or a combination of these elements or other attributes. Attributes evaluated by the marketing engine 207a may include, but are not limited to, personal information (name, address, age, sex, etc.), channel information (phone number, SMS address, email address, etc.), interactions and information pulled from third party resources, and purchase information. An example interaction engine is shown in FIG. 7, FIG. 8, and FIG. 9.

In at least one embodiment of the present disclosure, the marketing engine 207a may pull or receive interactions or information from third party data integrations through application programming interfaces or other interfaces for evaluation. These third party resources may include, but are not limited to, advertisement outlets, social media analysis engines (i.e. Radian6), social media advertisement tools (i.e. Buddy Media, SOCIAL.COM), CRM (i.e. Salesforce CRM), third party customer data integration engines (i.e. Heroku1 custom applications, Force.com), and other data integrations.

As shown, for example, in FIG. 2A, the marketing engine 207a may evaluate information stored in the change queue 206a in the order in which it was stored in the change queue 206a. In this example, the marketing engine 207a evaluates each record individually and generates marketing activity 208a if the process workflow associated with the event calls for the generation of marketing activity 208a. For example, if record <1> associated with David Lynch updating his email address to david.lynch@email.com is evaluated by the marketing engine 207a, a process workflow may identify that David Lynch is a high priority user and should be sent an email to confirm that his email address was successfully updated. In this example, the marketing engine 207a determine that an email should be generated and sent to David Lynch as marketing activity 208a. Next, the marketing engine 207a evaluates record <2> associated with David Lynch purchasing SKU#1213984 for mittens. In this example, the marketing engine 207a determines that David Lynch is a high priority user, uses information previously obtained about David Lynch, such as, for example, his address, and determines what, if any marketing activity 208a should be generated as a result of this change. In this example, the marketing engine 207a could determine that it should send a follow up email as marketing activity 208a to David Lynch in seven days asking David Lynch to rate the mittens he ordered. Then, when evaluating record <3> associated with David Lynch purchasing SKU #1213999 for skis, the marketing engine 207a may generate no marketing activity 208a in this example.

In at least one embodiment of the present disclosure, the marketing engine 207a evaluates information stored in the change queue 206a based on processes identified by an enterprise. In such an embodiment, the enterprise may create processes that generate marketing activity 208a in a way that attempts to engage a customer with the highest likelihood of conversion by the customer. As shown, for example, in FIG. 1B, an enterprise may classify customers based on the level of engagement of the customer and/or the stage at which the customer is engaged with the enterprise's brand. A customer classified in one category may be treated differently than a customer classified in another category. In at least one embodiment of the present disclosure, the marketing engine 207a may attempt to identify which classification is appropriate for a customer at the time the marketing engine 207a processes the information from the data queue 206a. In such an embodiment, the marketing engine 207a evaluates information previously stored about the customer to determine what classification to assign to the customer.

In at least one embodiment of the present disclosure, the marketing engine 207a may use information already known about a customer to determine what marketing activity 208a to generate based on the information processed from the change queue 206a. In such an embodiment, the marketing engine 207a may use any type of information previously stored about the customer by the enterprise, such as, for example, previous purchase history, personal information about the customer, previous communications sent to the customer, contact information, and other data. The marketing engine 207a may pull such information from data sources operated by the enterprise and/or external data sources, such as, for example, an external CRM application or such data sources may push information to the marketing engine 207a.

It should be appreciated that in this example, events are evaluated in real time or near real time such that marketing activity 208a is generated before each record is stored in the change queue 206a. For example, the marketing activity 208a generated based on David Lynch updating his email address in record <1> ideally should be generated and distributed before record <2> associated with David Lynch purchasing SKU #1213984 for mittens. Thus, diagram 200a represents a constant flow of information from the change queue 206a to marketing activity 208a with information being evaluated by the marketing engine 207a as soon as possible after being stored in the change queue 206a.

Referring now to FIG. 2B, a diagram 200b of a system and method for providing real time responses to customer activity is shown according to at least one embodiment of the present disclosure. As shown in FIG. 2B, the diagram 200b includes an application 201b, consumer information 204b, a change queue 206b, a marketing engine 207b, and resulting marketing activity 208b. In at least one embodiment of the present disclosure, a customer interacts with the application 201b in a way that generates new information about the customer. In such an embodiment, the application 201b is provided by an enterprise for interaction by the customer. For example, the customer may purchase a product, fill out a form to opt-in to receiving communications, “Like” a Facebook page, install a Facebook application, update personal information about the customer, or perform other tasks on the application 201b. In at least one embodiment of the present disclosure, the customer may interact with the application 201b by clicking a hyperlink within an email that references the application 201b and/or opening an email with a web beacon served by the application 201b.

In at least one embodiment of the present disclosure, by interacting with the application 201b the customer generates information that is stored within a database 204b for consumer information. In such an embodiment, the database 204b may store any type of information about the consumer and is populated upon interaction by the consumer through the application 201b.

It should be appreciated that any number of applications may generate information about the consumer that may be stored in any number of databases and/or data structures. For example, referring now to FIG. 2C, it is shown a diagram 200c of a system and method for providing real time responses to customer activity according to at least one embodiment of the present disclosure. As shown in FIG. 2C, an opt-in application 201c, an e-commerce application 202c, and an order processing application 203c all may generate information about a consumer that is stored in various data structures. As shown in FIG. 2C, an opt-in application 201c may generate consumer information that is stored in a database 204c. An e-commerce application 202c may generate consumer information that is stored in a database 204c and purchase history information that is stored in a database 205c. An order processing application 203c may generate purchase history information that is stored in a database 205c. In such an embodiment, as information changes within either database 204c, 205c, the information may be pushed to or pulled by a change queue 206c for evaluation by a marketing engine 207c. Upon evaluation by the marketing engine 207c, the marketing engine 207c may generate marketing activity 208c. Thus, it should be appreciated that any number of applications may generate any type of information stored within one or more databases that may push information to or be pulled by a change queue 206c for evaluation by a marketing engine 207c. This structure, therefore, enables a marketing engine 207c to evaluate changes in information as it occurs to provide real-time responses to consumers based on the consumer events that generate such information.

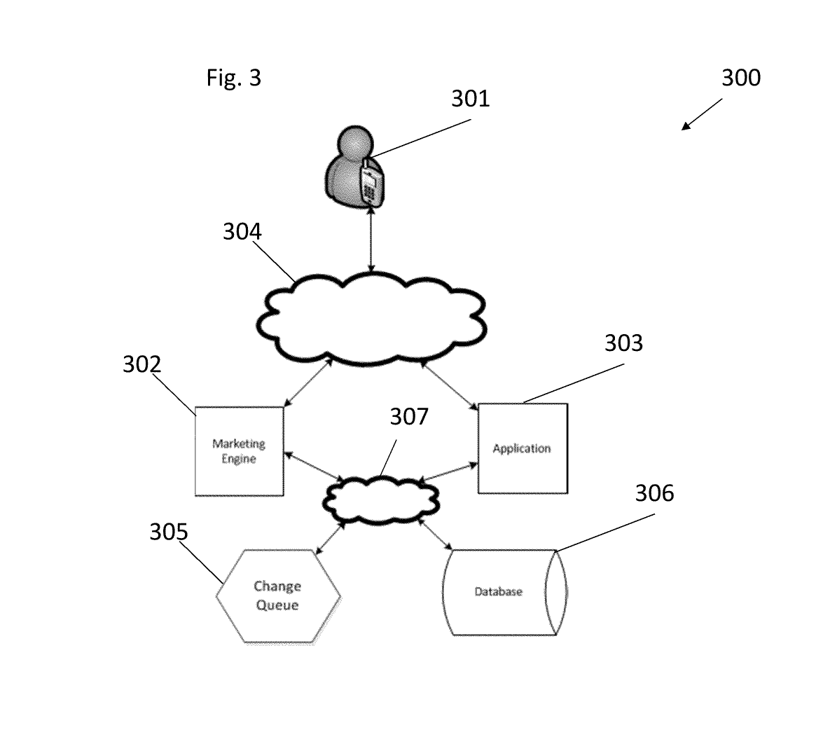

Referring now to FIG. 3, there is shown at least one embodiment of the components of the system for providing real-time response to customer activity 300 according to the present disclosure. System 300 comprises remote device 301, marketing engine 302, an application server 303, database 306, change queue 305 and computer networks 304, 307. For purposes of clarity, only one remote device 301 is shown in FIG. 3. However, it is within the scope of the present disclosure that the system 300 may have two or more remote devices 301 operating at the same time. In the embodiment shown in FIG. 3, remote device 301 is operated by a user or customer. It should be noted that at least in one embodiment of the present disclosure, the remote device 301 may be in any form of device that is capable of sending and receiving communications via a computer network, such as, for example, a smartphone, laptop, personal computer, tablet, Microsoft Xbox, gaming console, or other network-capable computing device.

The remote device 301 may be configured to send and receive content to the marketing engine 302 and the application server 303 via the computer network 304. In addition or alternatively, the remote device 301 may be configured to access and utilize an application hosted on application server 303 to generate activity associated with customer events, such as, for example, purchasing a product through the application, clicking a link within an email that references the application, opening an email with a web beacon served by the application, and other types of interactions with the application hosted on the application server 303. Remote device 301 comprises such software, hardware, and componentry as would occur to one of skill in the art, such as, for example, one or more microprocessors, memory systems, input/output devices, device controllers, and the like. Remote device 301 also comprises one or more data entry means (not shown in FIG. 3) operable by users of first remote device 301 for data entry, such as, for example, a pointing device (such as a mouse), keyboard, touchscreen, microphone, voice recognition, and/or other data entry means known in the art. Remote device 301 also comprises a display means (not shown in FIG. 3) which may comprise various types of known displays such as liquid crystal diode displays, light emitting diode display, and the like upon which information may be display in a manner perceptible to the user.

As described above, the marketing engine 302 and application server 303 may be configured to send and receive content to/from the remote device 301, host an application for the remote device 301 to interact, and to generate marketing activity from the marketing engine 302 to the remote device through the computer network 304. In at least one embodiment, the application server 303 and marketing engine 302 accesses the database 306 to associate activity generated by a customer or user on the remote device 301 with information previously stored about such customer or to populate new data entry fields for new customers or new customer activity.

Marketing engine 302 and application server 303 comprise one or more server computers, computing devices, or systems of a type known in the art. Marketing engine 302, application server 303 and change queue 305 further comprise such software, hardware, and componentry as would occur to one of skill in the art, such as, for example, microprocessors, memory systems, input/output devices, device controllers, display systems, and the like. Marketing engine 302, application server 303 and change queue 305 may comprise one of many well-known servers, such as, for example, IBM's AS/400 Server, IBM's AIX UNIX Server, or MICROSOFT's WINDOWS NT Server. In FIG. 3, marketing engine 302, application server 303 and change queue 305 are each shown and referred to herein as a single server. However, marketing engine 302, application server 303 and change queue 305 may comprise a plurality of servers or other computing devices or systems interconnected by hardware and software systems know in the art which collectively are operable to perform the functions allocated to host server 260 in accordance with the present disclosure. It should be appreciated that although application server 303, marketing engine 302, and change queue 305 are displayed as separate items in the system 300, it is within the scope of the present disclosure for one or more these components to reside on the same infrastructure and communicate locally via a LAN, bus, or other internetworking functionality.

The database 306 is configured to store data extensions, contact attributes, recipient demographic information, content, and other information. Database 306 is “associated with” change queue 305, marketing engine 302, application server 303 and may communicate with these components through computer network 307. According to the present disclosure, database 306 can be “associated with” change queue 305, application server 303, and marketing engine 302 where database 306 resides on one or more of marketing engine 302, application server 303, and change queue 305. Database 306 can also be “associated with” marketing engine 302, change queue 305, and application server 303 where database 306 resides on a server or computing device remote from marketing engine 302, change queue 305, and application server 303, provided that the remote server or computing device is capable of bi-directional data transfer through a computer network 307. In at least one embodiment, the remote server or computing device upon which database 306 resides is electronically connected to a computer network 307 such that the remote server or computing device is capable of continuous bi-directional data transfer with other components connected to the computer network 307.

For purposes of clarity, database 306 is shown in FIG. 3, and referred to herein as a single database. It will be appreciated by those of ordinary skill in the art that database 306 may comprise a plurality of databases connected by software systems of a type well known in the art, which collectively are operable to perform the functions delegated to database 306 according to the present disclosure. It should be appreciated that, as disclosed in FIG. 2C, it is within the scope of the present disclosure for the system 300 to include more than one database 306 and that each database may store information used by components of the system 300. Database 306 may comprise a relational database architecture or other database architecture of a type known in the database art. Database 306 may comprise one of many well-known database management systems, such as, for example, MICROSOFT's SQL Server, MICROSOFT's ACCESS, or IBM's DB2 database management systems, or the database management systems available from ORACLE or SYBASE. Database 306 retrievably stores information or documents that are communicated to database 306 from remote device 301 through the application server 303 or marketing engine 302 or through computer network 307.

Remote device 301 communicates with application server 303 and marketing engine 302 via computer network 304. The communication between first remote device 220 and host server 260 may be bi-directional. Computer network 304 may comprise the Internet, but this is not required. Marketing engine 302, application server 303, change queue 305 and database 306 communicate together through computer network 307. In an exemplary embodiment, computer network 307 is an internal and private network. It is within the scope of the present disclosure that computer network 307 comprises a network that is routable to the Internet, but this is not required.

Change queue 305 may be implemented as any type of server or infrastructure hosting an application that provides access to a queuing structure or data structure, including, but not limited to, a FIFO queue, a linked list, a priority queue, a circular buffer, a stack, or tree. The change queue 305 may also be implemented as a server or infrastructure providing message queuing technologies, such as, for example, IBM Websphere, Apache Kafka, Apache ActiveMQ, Oracle AQ, StormMQ, IronMQ, or Solace. In at least one embodiment of the present disclosure, the change queue 305 utilizes bidirectional communication through the computer network 307.

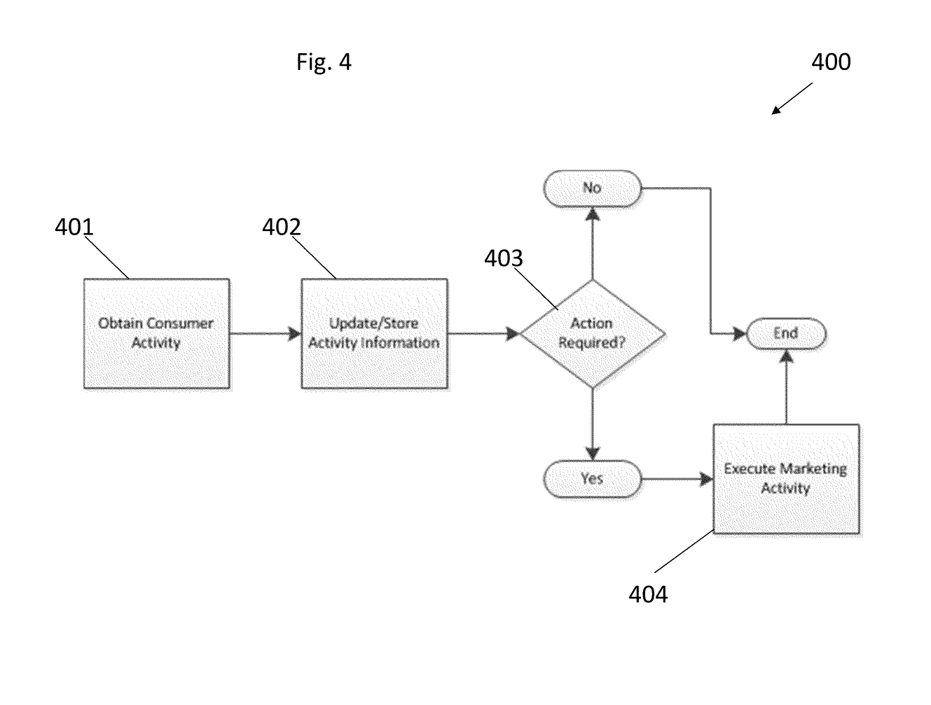

Referring now to FIG. 4, it is shown a method 400 for providing real-time response to customer activity according to at least one embodiment of the present disclosure. As shown in FIG. 4, the method 400 includes obtaining consumer activity in step 401, updating and storing activity information in step 402, determining whether the updated or stored activity information matches an interaction in step 403, and executing marketing activity in step 404.

In at least one embodiment of the present disclosure, the method 400 includes obtaining consumer activity in step 401. In at least one embodiment of the present disclosure, a consumer interacts with a brand in a way that generates information associated with the interaction. In at least one embodiment of the present disclosure, by interacting with the brand, the consumer provides activities that generate information, such as, for example, purchasing a product, choosing to “Like” a Facebook presence or post, providing an email address to opt-in to receiving communications, filling out a form, clicking a hyperlink within an email, or other types of consumer activity. In such an embodiment, information generated during customer activities is obtained in step 401.

In at least one embodiment of the present disclosure, information obtained in association with the consumer activity is updated or stored as activity information in step 402. In at least one embodiment of the present disclosure, information previously known or stored about a consumer is evaluated to determine whether the information associated with consumer activity obtained in step 401 might change previously known or stored information in step 402. In an exemplary embodiment, information is stored or updated within a database in step 402. In such an embodiment, the database may create events associated with any updates or changes that flow to a message queue or other queuing structure for evaluation.

In at least one embodiment of the present disclosure, information generated due to consumer activity related to a brand in step 401 and updating and storing activity information about the consumer in step 402 happen in succession as quickly as possible. In such an embodiment, the quick flow of information from step 401 to step 402 helps achieve a faster response to consumer activity at a time when the consumer is already engaged with the brand. In such an embodiment, a consumer may be more likely to further engage a brand in the event that the consumer receives additional coupons, offers, or communication from the brand at a very close proximity in time to when the consumer generated some activity that showed interest in the brand, such as, for example, when the consumer purchased a product.

For example, a speaker at a conference may ask the audience to SMS a number with their email address in order to receive the slides from the presentation by the speaker and to join the speaker's mailing list. A consumer in the audience who sends an SMS to the number provided by the speaker with the consumer's email address would include consumer activity obtained in step 401. The information associated with the consumer activity obtained in step 401 include the mobile phone number of the consumer and the consumer's email address. In this example, the information provided by the consumer is evaluated to determine whether any information should be updated or stored about the consumer in step 402. In this example, an enterprise may already know the email address of the consumer and can associate the information provided by the consumer in step 401 with the record through that email address. In this example, however, the enterprise may not have known the consumer's mobile number and the enterprise did not associate the consumer's record as opt-in to the speaker's mailing list. Therefore, in this example, the consumer's mobile address is stored and a record is added indicating that the consumer joined the speaker's mailing list in step 402. In an exemplary embodiment in this example, this information is stored within a relational database and the two modifications to the record concerning the consumer are sent individually to a message queuing service for evaluation in subsequent steps of the method 400. In this example in an exemplary embodiment, an individual message is sent to a queue indicating that the mobile address of the consumer has changed and an individual message is sent to a queue indicating that a consumer has joined the speaker's mailing list.

In at least one embodiment of the present disclosure, the method 400 includes determining whether action is required in step 403. In such an embodiment, an enterprise may wish to generate marketing activity based on information obtained during consumer activity to try to further engage the consumer. In such an embodiment, an enterprise may create a business process to evaluate whether to generate marketing activity based on information processed in step 403. The business process may evaluate newly updated and stored information in step 402 against conditionals that take action based on previously known information about the consumer in step 403. In such an embodiment, an enterprise may already have stored information about a consumer prior to obtaining new consumer activity in step 401. This information may include, but is not limited to, purchase history, contact information, opt-in mailing lists, website activity, email open rates, email click rates, and other types of metrics about a consumer. In such an embodiment, when determining whether to generate marketing activity for the newly obtained consumer activity, the business process may evaluate the newly obtained consumer activity against conditionals that determine what type of customer has provided this activity, what types of communications have already been sent to the customer, and/or how the customer is classified. For example, in the event that a consumer opens an email, consumer activity associated with the email opening is obtained in step 401. In this example, the email open is stored as activity information in step 402. Then, in this example, a business process is executed to determine what, if anything, should be done based on the consumer opening the email. In one example, the business process may choose to set up a timer that follows up with the consumer about an advertisement within an email in three days. In another example, the business process may generate a specialized coupon for the consumer that offers an extra discount if the consumer purchases a product displayed in the opened email within twenty-four hours. In these examples, what marketing activity to generate may be determined based on previously known information about the consumer. For example, if the enterprise has determined that the consumer is a highly engaged customer that responds positively to coupons and VIP offerings, in response to the consumer opening the email, the example above which sends the consumer a specialized coupon may be generated because it has the highest likelihood of further engaging the consumer. In another example, if the enterprise has determined that the consumer responds positively to telephone calls which offer the consumer a special discount, the business process may create a ticket within a CRM system to ask that a sales representative follow up with the consumer with a special offer based on the products displayed in the email opened by the consumer. It should be appreciated, then, that the method 400 supports any type of business process based on information generated through consumer activity and is able to process what, if any, actions to perform based on previously known information about the consumer.

It should further be appreciated that the method 400 may support integrations with third party resources generating consumer activity as input (i.e. Radian6, Salesforce CRM, Salesforce Heroku1 Apps, etc.) and/or accessing third party resources to perform communication activities (i.e. SOCIAL.COM, Buddy Media, Salesforce Heroku1 Apps, etc.).

In at least one embodiment of the present disclosure, the method 400 includes executing marketing activity in step 404. In such an embodiment, in the event that a business process evaluated in step 403 requires that marketing activity be performed based on the information generated during consumer activity, the marketing activity is executed in step 404. In such an embodiment, marketing activity includes further communications, offers, or follow-ups with the consumer in an effort to engage the consumer and generate an additional sale, an opt-in to receiving more information, or other positive marketing activity or conversion. It should be appreciated that marketing activity may also include accessing an external data source, such as, for example, a remote CRM, and populating the remote data source with information.

In an exemplary embodiment, the method 400 includes a flow of information with sequential steps 401, 402, 403, and 404 that are executed as soon as possible one after another. In such an embodiment, by obtaining consumer information, determining what activities should be performed based on the consumer information, and then generating marketing activity to the consumer in as quick of a time as possible creates the highest likelihood of engagement by the consumer based on the marketing activity generated. In such an embodiment, a consumer is more likely to respond positively to follow-up communications and further engagement in the event that the activity is relevant to what the consumer is doing. In an exemplary embodiment, then, an enterprise wants to immediately engage the consumer based on the activities performed by the consumer showing interest in the brand, and the method 400 is executed as quickly as possible for this engagement to occur.

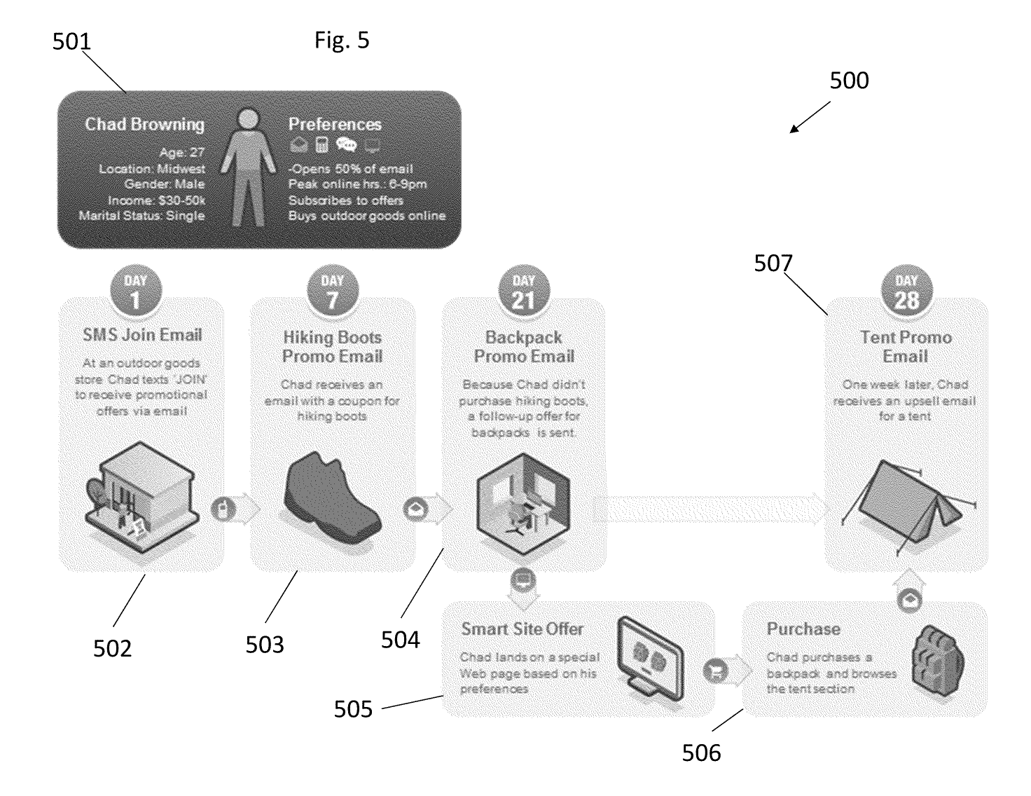

Referring now to FIG. 5, a flowchart of a process 500 showing an example of an execution of the methods herein for engaging a consumer in reaction to consumer events is shown according to at least one embodiment of the present disclosure. It should be appreciated that the process 500 is merely an example of a process for engaging a consumer that might be executed through one or more of the methods disclosed herein. For example, the process 500 includes information previously known about the consumer 501. In this example, an enterprise already knows much information about the consumer, including the consumer's name, age, geographic location, gender, income, marital status, and marketing preferences. For example, the enterprise has obtained information that the consumer is generally online between the hours of 6 pm and 9 pm and that the consumer likes to buy outdoor goods online. In this example, the enterprise may have obtained this information by the consumer populating a web form, purchasing products on the enterprise's website, or through combining information from multiple sources to generate information.

In this example, the consumer texts the word “JOIN” to the enterprise in order to receive promotional offers 502. In this example, the text from the consumer may indicate consumer activity obtained by the enterprise as disclosed in the method 400. In response to this consumer activity, the enterprise evaluates how to best engage the consumer based on information known about the consumer 501 and marketing processes defined by the enterprise (not pictured). In this example, the enterprise waits seven days before following up with the consumer with an email that provides a coupon for hiking boots 503. In this example, the email is related to the consumer showing interest in the brand through a text message 502 and based on information already known about the consumer 501, such as, for example, that the consumer purchases outdoor goods online.

Then, in this example, the enterprise waits to see whether the consumer performs an action based on the marketing communication. Here, the consumer did not purchase the hiking boots from the email offer 503 after an additional fourteen days, so the enterprise sends a follow up offering for a backpack through email 504. When the consumer clicks on a hyperlink within the email offering, he is presented with a special website offer 505 based on previously known information about the consumer 501. In this example, the consumer purchases a backpack but also browses through the selection of tents available on the website 506. In this example, the consumer purchasing the backpack is indicative of consumer activity that will generate information to be processed by the enterprise. In addition, the consumer browsing the selection of backpacks without making a purchase also creates consumer activity with information to be processed by the enterprise. In this example, the enterprise processes the information related to the fact that the consumer browsed the tent selection but failed to make a purchase and sends a follow-up email 507 to the consumer in an attempt to sell a tent through a specialized offering. In this example, the follow-up email 507 may be generated based on evaluating the incoming consumer activity that the consumer browsed the tent selection without making a purchase with previously known information about the consumer, such as, for example, the fact that consumer purchased a backpack. Therefore, in this example, it should be appreciated that the methods and systems disclosed herein enable an enterprise to react to consumer activity in a way that evaluates such activity against previously known information about the consumer to try to engage the consumer in a way that has the highest chance of conversion.

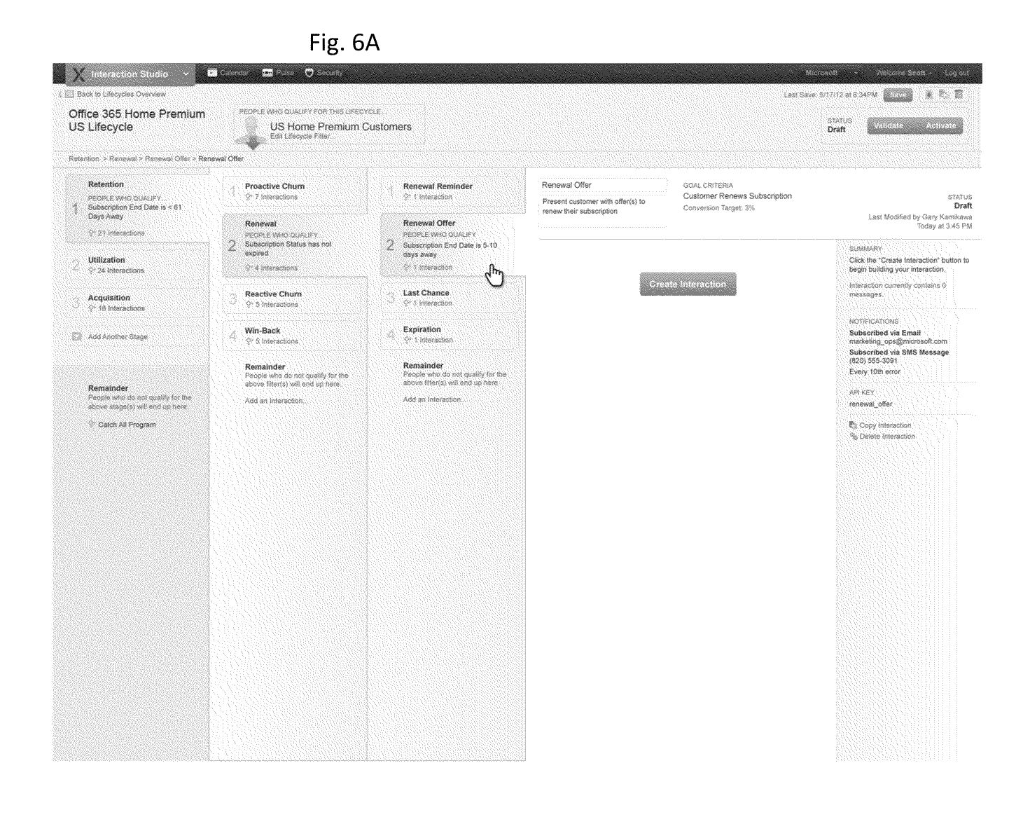

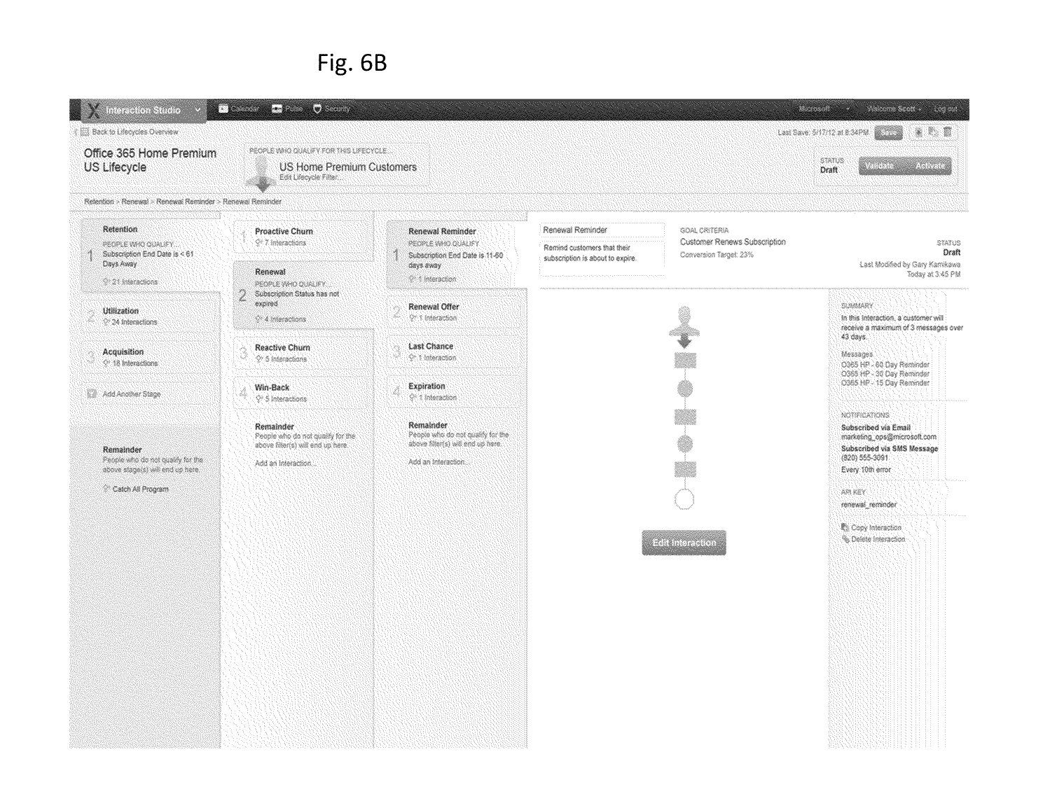

Referring now to FIG. 6A, it is shown a screenshot of a graphical user interface for providing real-time response to customer activity according to at least one embodiment of the present disclosure. As shown in FIG. 6A, an enterprise may be presented with a graphical user interface that enables the enterprise to create interaction processes to evaluate incoming consumer activity. As shown in the screenshot, the enterprise may select and create interactions to generate marketing activity based on the type of consumer and/or type of consumer activity obtained. In addition, an enterprise may edit interactions created as shown, for example, in FIG. 6B.

Referring now to FIG. 7, it is shown a screenshot of an example process for evaluating how to respond to consumer activity according to at least one embodiment of the present disclosure. In the screenshot, an enterprise may create a process to evaluate how to process incoming customer activity in order to generate marketing activity to try to further engage the customer. In the example shown in the screenshot, the enterprise has created a business process with an entry criteria that the end date of a certain subscription is about to end. In this example, when the criteria is matched in the entry criteria, the enterprise sends an offer to the consumer through email. In this example, the enterprise waits three days and then, depending on the type of consumer engaged, sends a follow-up communication. In this example, if the consumer is identified as a “High Value Customer” 701, the consumer receives one of three offers from the enterprise. If the consumer is not identified as a “High Value Customer” 701, then the consumer receives a reminder email message with the previously sent offer. In this example, the screenshot indicates that there are three options for communications sent to consumers identified as a “High Value Customer” 701. When executing this process, which communication to generate and send may be randomized with 90% of consumers receiving the “A” communication, 5% receiving the “B” communication, and 5% receiving the “C” communication. It should be appreciated, as shown in this example, that the process may include email messages, SMS, Facebook Messages, Tweets, and other types of communications. It should be appreciated, as shown in the example screenshot, that the enterprise may modify this process using the drag and drop icons associated with establishing a schedule or cadence, selecting which types of messages to send, creating decisions based on data or consumer activity, and performing outbound API calls or including AMP Script functionality. It should be appreciated that any type of business process for evaluating incoming consumer activity is within the scope of the present disclosure to be generated in the systems and methods disclosed herein.

An example of a second screenshot 801 of a graphical user interface showing creation of an interaction for providing real-time response to consumer activity is shown in FIG. 8. In this example, metrics from execution of the process displayed in FIG. 7 are shown. As shown in FIG. 8, the number of conversions from the types of communications sent through execution of the process shown in FIG. 7 are displayed, such as, for example, sending the initial offer resulted in 2.6% of conversions and that 2.3% of these conversions occurred in the first day after sending the offer. It should be appreciated that this information presented to the enterprise may help facilitate the enterprise in refining the process and increasing the likelihood of conversion.

In addition, the screenshot displays that the “Winning Path” 801 has been identified based on activity by the consumer in response to communications sent through execution of the process. As shown in this example, 3.5% of “High Value Customer” consumers responded positively to or converted to a mobile offering as a follow-up communication. In this example, the enterprise is able to determine that the “Winning Path” 801 creates a higher likelihood of conversion and, therefore, may choose to send all communications through the “Winning Path” 801. It should be appreciated that it is within the scope of the present disclosure for the system and methods to automatically choose the “Winning Path” 801 for future communications even if the enterprise does not manually select the “Winning Path” 801.

Referring now to FIG. 9, it is shown a screenshot 900 of a graphical user interface for providing real-time response to customer activity. As shown in FIG. 9, the graphical user interface enables an enterprise user to define one or more interactions for incoming content based on triggers, activities, and a logic tree. For example, the graphical user enables an enterprise user to define a trigger which activates the interaction plan. As used in the present disclosure, a trigger is an evaluation of customer activity that would activate an interaction plan. A trigger may include, but is not limited to, any customer activity where an enterprise may wish to further engage the underlining customer with an interaction. Triggers may include customer activity generating from communications (i.e. click activity, email open, etc.), third party data integrations (i.e. Salesforce CRM, Salesforce Heroku1 Customer Apps, and others), purchase activity of products on an ecommerce site or point-of-sale location, an acknowledgment that a customer passed through a geo-fence, a customer signing up for a newsletter, or any set of custom criteria based on an analysis of incoming customer activity. For example, a trigger may include a notification that a customer has added one or more items to an online shopping cart but failed to purchase any of the items within a twenty-four hour time period.

In another example, the triggered event may be related to customer activity arriving from a third party data integration that monitors social media behavior, like Radian6. In this example, the Radian6 platform may analyze conversations within social media and send aggregate customer activity for analysis which can be used in trigger events. For example, a social media monitoring platform, like the Radian6 platform, may generate customer activity as input to an interaction that a certain keyword is heavily being discussed in social media related to an enterprise. A trigger event may be created that is activated when a keyword reaches a set number of social media events. In another example, the platform may send aggregate information that an enterprise is being discussed negatively, and a trigger event may be configured to activate an interaction based on this evaluation.

For example, a social media monitoring platform (i.e. Radian6) may determine that a relatively high number of tweets are present which negatively discuss a Comcast service outage. In this example, the social media monitoring platform may send this information as consumer activity which triggers an interaction. The interaction may be further configured to pull the identities of the authors of the negative tweets through the social media monitoring platform in order to send targeted offers for service rebates or communications directed to the authors apologizing for the outage. In this example, it should be appreciated that the social media monitoring platform may identify the Twitter handle for each negative tweet about Comcast and the interaction may be configured to reference the Twitter handle against a database of consumer information known by the enterprise to identify an alternate communication channel for the enterprise. For example, the negative tweets trigger positive-focused emails (i.e. offers for rebates, apologetic communications) to the authors through the interaction. This Twitter channel analysis and email channel communication may provide a heightened opportunity for positive engagement with the consumer based on real time or near real time analysis of social media activity through the third party social media monitoring platform.

The interaction may further enable an enterprise user to update known information about a consumer based on the triggered event through manipulation of a data element 901 within a database. The interaction may be configured, for example, to, upon receiving the trigger event, to cause a customer's profile to be associated with a different phase in the customer lifecycle, such as, for example, the phases outlined in FIB. 1B. In another example, the triggered event could cause a data manipulation to occur to place the customer into categories based on the customer's likelihood to consume additional marketing materials, such as, for example, a highly-engaged customer. It should be appreciated that the data element 901 may perform any data-related task based on receiving the trigger event. For example, the data element 901 could be configured to associate with the that such customer has opted in to receiving an enterprise newsletter.

The interaction further enables an enterprise to take communication actions based on the triggered event over a timeframe. For example, the communication action 902 shown in screenshot 900 would send an email to the customer a day after receiving the trigger event. In this example, the email could be created and send built on previously submitted or designed email template or other content. Although the example shown in screenshot 900 is related to an email, the communication action may include any marketing activity, such as, for example, sending an SMS, MMS, tweet, direct message, LinkedIn message, Facebook message, or other type of communication to the consumer.

The communication action may also call third party resources through integration. For example, the interaction may be configured to integrate with a third party social media marketing engine, such as SOCIAL.COM, such that the communication action creates a targeted social marketing advertisement for the consumer through the social media marketing platform, like the SOCIAL.COM platform, based on receiving the trigger event. The third party integration may further include independent software vendors, like commercial applications built on the FORCE.COM platform, HEROKU, or on ISVForce, as well as through the Fuel platform provided by ExactTarget, Inc. For example, an interaction could be configured with a trigger event that a consumer has rented the movie Robocop from a Redbox kiosk. The interaction, then, may be configured to call the social media marketing platform to create an advertisement targeted to the consumer over the consumer's Facebook account to, for example, ask the consumer to “Like,” Follow, or suggest that Friends Follow the Robocop Facebook page.

In another example, an interaction could be configured with a trigger event that a consumer has received an introduction communication for registration with Redbox without opening the communication. In this example, the interaction may be configured to call upon a third party social media advertising engine (i.e. SOCIAL.COM) to generate a social-based advertisement to try to engage the consumer to open the registration communication in another manner. For example, the third party social media advertising engine may create a targeted advertisement in Facebook that appears as a banner advertisement asking the consumer to open his or her registration email from Redbox.

In another example, the interaction may include a triggered event of a consumer “Like”ing the Facebook page. In this example, the interaction may further include a communication activity that makes a remote application programming interface call to a specialized social media advertisement platform, like the Buddy Media platform, that directs the platform to send a special offer to the consumer. It should be appreciated that the third party data integrations discussed herein are merely examples and that the triggered event and/or communication activity may include any integration with any third party marketing resource, such as, for example, social media advertising (Buddy Media, SOCIAL.COM), social media scoring (Radian6, Klout), or other integrations.

In at least one embodiment of the present disclosure, the graphical user interface is further configured to enable an enterprise user to establish a cadence and make a logic-based decision on whether to send further communications or perform additional steps. As shown in the screen 900, for example, the logic choice 903 occurs three days after the first communication activity 902. This logic choice 903 may be configured to perform any Boolean operands on known information about consumers, like whether the communication sent from the communication activity 902 was opened or otherwise interacted with, whether the consumer purchased products in an abandoned shopping cart, or other activity. The logic choice 903 may also be an evaluation of other categorical information known about the consumer, such as, for example, demographic information, whether the consumer is a High Value or highly engaged consumer, or other information. Based on the logic choice 903, the interaction may further be configured to perform additional communication activities 904 at a later time.

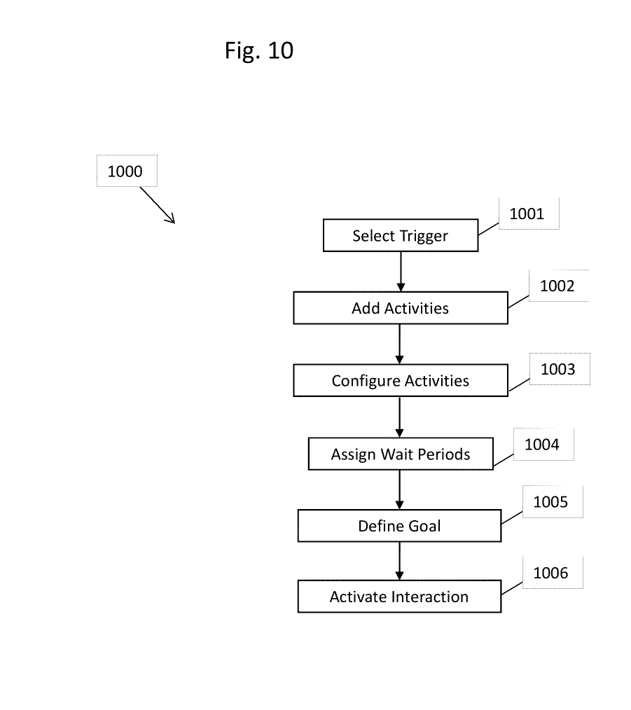

Referring now to FIG. 10, it is shown a method 1000 for the creation of an interaction to respond in real time to consumer activity according to at least one embodiment of the present disclosure. As shown in FIG. 10, the method 1000 includes selecting a trigger 1001, adding activities 1002, configuring activities 10023, assigning wait periods 1004, defining goals 1005, and activating the interaction 1006. It should be appreciated that the execution of the method 1000 may be performed by an enterprise user providing input through a graphical user interface to a software-as-a-service application over the Internet, such as, for example, the ExactTarget Marketing Cloud.

In at least one embodiment of the present disclosure, the method 1000 includes selecting a trigger in step 1001. In such an embodiment, an enterprise user may interact with a software-as-a-service application over the Internet to select one or more trigger events for use in an interaction. As discussed above, the trigger events identify a result to trigger an interaction based on analysis of incoming consumer. The triggered events may include a Boolean operand analysis of incoming consumer activity or other type of analysis of consumer activity. It should be appreciated that the interaction may include more than one triggered events that are joined by Boolean operands to determine whether the interaction should be activated.

In at least one embodiment of the present disclosure, the method 1000 includes adding activities in step 1002 and configuring activities in step 1003. In such an embodiment, a graphical user interface may be configured to enable an enterprise user to select communication activities to add to an interaction in step 1002, like sending an email, SMS, MMS, social media message, or call to a third party integrated resource to perform activities (i.e. SOCIAL.COM). In such an embodiment, the enterprise user may further configure the activities in step 1003. It should be appreciated that a configuration for an activity in step 1003 may vary based on the type of activity selected in step 1002. For example, configuring an activity to send an email in step 1003 may require an enterprise user to select an email template, a list of recipients, a marketing campaign, and other pertinent information for building and sending emails. Alternatively, if the activity to be configured in step 1003 is a call to a third party resource to generate communication activity, the enterprise user may have to define the third party resource, the type of activity to be performed by the third party resource and other options. In this example, the third party resource may further present configuration options that are related to communication activities available on the resource. For example, if the activity is a call to a third party social media advertising resource, like SOCIAL.COM, the resource may present options for the enterprise user to select the social media channel to use and the type of communication to generate in the channel (i.e. tweet, direct message, Facebook message, wall post, etc.).

In at least one embodiment of the present disclosure, the method 1000 further includes assigning wait periods in step 1004. It should be appreciated an enterprise may not wish to generate all communication activity based on a triggered event immediately upon realizing the triggered event occurred. The enterprise may wish to send a communication on one day, wait to see if the communication is opened and reviewed by a recipient, and then take action at a subsequent day based on that analysis.

For example, an interaction may activate based on a triggered event that a consumer has abandoned a shopping cart for 24 hours. In this example, the enterprise may send an email immediately to the consumer upon this realization as an activity that reminds the consumer that he or she has abandoned the shopping cart and provides a link to review the shopping cart. Then, the interaction may be configured to include a wait period in step 1004 of a set timeframe (i.e. one day, two days, six hours, etc.). After the wait period, the interaction may include an additional activity, like, in this example, sending an SMS to the consumer reminding him or her again of the abandoned shopping cart and offering free shipping if the consumer makes a purchase from it. It should be appreciated, then, that assigning wait periods in step 1004 give the enterprise additional flexibility to control the interaction with the consumer based on the triggered event.

In at least one embodiment of the present disclosure, a goal may be defined in step 1005 that, when achieved, generates a notification of achievement, ends the interaction, or otherwise performs an additional activity based on its realization. The goal may be linked to additional consumer activity, like a percentage of conversions from communication activities within the interaction. In step 1006, the interaction may be activated which will start the process of analyzing incoming consumer activity for the triggers selected in step 1001.

While the description above refers to particular embodiments of the present invention, it will be understood that many modifications may be made without departing from the spirit thereof. The accompanying concepts are intended to cover such modifications as would fall within the true scope and spirit of the present invention. The presently disclosed embodiments are therefore to be considered in all respects illustrative and not restrictive, the scope of the invention being indicated by the appended concepts, rather than the foregoing description, and all changes which come within the meaning and range of equivalency of the concepts are therefore intended to be embraced therein.

What is claimed is:

1. A computerized method for providing real-time response to consumer activity, the method comprising:
receiving a consumer activity, the consumer activity being associated with marketing engagement by a consumer;
analyzing the consumer activity to determine one or more changes to previously known attributes of the consumer stored in a database;
pushing the one or more changes into a data queue;
processing the one or more changes from the data queue based on a business logic process, the business logic process comprising one or more marketing activities and a timing for each marketing activity of the one or more marketing activities; and
performing the one or more marketing activities directed to the consumer based at least in part on the business logic process.

2. The method of claim 1, wherein the timing for each marketing activity is a number of days to wait in between performing each marketing activity of the one or more marketing activities.

3. The method of claim 1, wherein at least one of the one or more marketing activities is configured to request a third party resource to generate marketing communication for the consumer.

4. The method of claim 1, wherein at least one of the one or more marketing activities is a special offer for the consumer distributed over a social media channel.

5. The method of claim 1, wherein the data queue is configured as a message queue.

6. The method of claim 1, wherein the business logic process further comprises at least one Boolean operand associated with the one or more marketing activities.

7. The method of claim 1, wherein the business logic process further comprises a goal, the goal defining a level of desired marketing engagement.

8. The method of claim 7, further comprising:
receiving and evaluating additional consumer activity against the level;
generating a goal status based on a percentage of completion of the level; and
reporting the goal status.

9. The method of claim 7, wherein the business logic process further comprises a Boolean operand associated with the level.

10. The method of claim 1, wherein at least one of the one or more changes is indicative of a change to a derived attribute for the consumer.

11. A system for providing real-time response to consumer activity, the system comprising:
a computer network;
a database;
a data queue; and
a host server, the host server operably connected to the database over the computer network and configured to:
receive a consumer activity over the computer network, the consumer activity being associated with marketing engagement by a consumer;
analyze the consumer activity to determine one or more changes to previously known attributes of the consumer stored in the database;
pushing the one or more changes into the data queue;
process the one or more changes from the data queue based on a business logic process, the business logic process comprising one or more marketing activities and a timing for each marketing activity of the one or more marketing activities; and
perform the one or more marketing activities based at least in part on the business process.

12. The system of claim 11, wherein each timing is a number of days to wait in between performing each marketing activity of the one or more marketing activities.

13. The system of claim 11, wherein at least one of the one or more marketing activities is configured to request a third party resource over the computer network to generate marketing communication for the consumer.

14. The system of claim 11, wherein at least one of the one or more marketing activities is a special offer for the consumer distributed over a social media channel.

15. The system of claim 11, wherein the data queue is a message queue.

16. The system of claim 11, wherein the business logic process further comprises at least one Boolean operand associated with the one or more marketing activities.

17. A computerized method for building a graphical marketing automation campaign, the method comprising:
identifying a triggering event for a graphical marketing automation campaign, the triggering event defining an activation criteria based on consumer activity;
adding one or more communication activities in an order to the graphical marketing automation campaign, the one or more communication activities being associated with building and sending communications;
associating a content and time period for each of the one or more communication activities; and
upon receiving an indication that the triggering event has occurred based on the consumer activity meeting the activation criteria, processing the communication activities in the order through the graphical marketing automation campaign based on the indication.

18. The method of claim 17, further comprising:
receiving a consumer activity, the consumer activity being associated with marketing engagement by a consumer;
analyzing the consumer activity to determine one or more changes to previously known attributes of the consumer stored in a database;
pushing the one or more changes into a data queue;
processing the one or more changes from the data queue based on the graphical marketing automation campaign; and
performing the one or more marketing activities based at least in part on the graphical marketing automation campaign.

19. The method of claim 17, wherein the time period is a number of days to wait in between performing each communication activity of the one or more communication activities.

20. The method of claim 17, wherein at least one of the one or more communication activities is configured to request a third party resource to generate a marketing communication for the consumer.
